(19) United States
(12) Patent Application Publication
(10) Pub. No.: US 2005/0271908 A1
(43) Pub. Date: Dec. 8, 2005

(54) Cooling subsystem for an electrochemical fuel cell system

(76) Inventors: Bruce Lin, Vancouver (CA); Amy Nelson, Vancouver (CA); Alvin N. L. Lee, Vancouver (CA); Jean St-Pierre, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/860,554

(22) Filed: Jun. 2, 2004

(51) Int. Cl. H01M 8/00

(52) U.S. Cl. 429/13; 429/26

(57) ABSTRACT

A method for operating a cooling subsystem of an electrochemical fuel cell system during startup is disclosed. The method comprises directing a startup coolant through an electrochemical fuel cell stack of the fuel cell system, and directing a standard coolant through the fuel cell stack when the temperature of either the fuel cell stack or the startup coolant reaches a first predetermined temperature, wherein the heat capacity of the startup coolant is different from than the heat capacity of the standard coolant. Cooling subsystems are also disclosed.

### BACKGROUND OF THE INVENTION

1. Field of the Invention

The present invention relates to electrochemical fuel cells and electrochemical fuel cell systems, and, more particularly, to subsystems and methods for controlling the temperature of an electrochemical fuel cell system during startup.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area of the fuel cell.

Polymer electrolyte membrane (PEM) fuel cells generally employ a membrane electrode assembly (MEA) comprising a solid polymer electrolyte or ion-exchange membrane disposed between two electrode layers comprising a porous, electrically conductive sheet material, such as carbon fiber paper or carbon cloth, as a fluid diffusion layer. In a typical MEA, the electrode layers provide structural support to the ion-exchange membrane, which is typically thin and flexible. The membrane is ion conductive (typically proton conductive), and also acts as a barrier for isolating the reactant streams from each other. Another function of the membrane is to act as an electrical insulator between the two electrode layers. A typical commercial PEM is a sulfonated perfluorocarbon membrane sold by E.I. Du Pont de Nemours and Company under the trade designation NAFION®.

As noted above, the MEA further comprises an electrocatalyst, typically comprising finely comminuted platinum particles disposed in a layer at each membrane/electrode layer interface, to induce the desired electrochemical reactions. The electrodes are electrically coupled to provide a path for conducting electrons between the electrodes through an external load.

In a fuel cell stack, the MEA is typically interposed between two separator plates that are substantially impermeable to the reactant fluid streams. The plates act as current collectors and provide support for the electrodes. To control the distribution of the reactant fluid streams to the electrochemically active area, the surfaces of the plates that face the MEA may have open-faced channels formed therein. Such channels define a flow field area that generally corresponds to the adjacent electrochemically active area. Such separator plates, which have reactant channels formed therein, are commonly known as flow field plates.

In a fuel cell stack, a plurality of fuel cells are connected together, typically in series, to increase the overall output power of the assembly. In such an arrangement, one side of a given separator plate may serve as an anode plate for one cell and the other side of the plate may serve as the cathode plate for the adjacent cell. In this arrangement, the plates may be referred to as bipolar plates.

The fuel fluid stream that is supplied to the anode typically comprises hydrogen. For example, the fuel fluid stream may be a gas such as substantially pure hydrogen or a reformate stream containing hydrogen. Alternatively, a liquid fuel stream such as aqueous methanol may be used. The oxidant fluid stream, which is supplied to the cathode, typically comprises oxygen, such as substantially pure oxygen, or a dilute oxygen stream such as air.

In a fuel cell stack, the reactant streams are typically supplied and exhausted by respective supply and exhaust manifolds. Manifold ports are provided to fluidly connect the manifolds to the flow field area and electrodes. Manifolds and corresponding manifold ports may also be provided for circulating a coolant fluid through interior passages within the fuel cell stack to absorb heat generated by the exothermic fuel cell reactions. In this regard, the preferred operating temperature range for PEM fuel cells is typically between 50° C. to 120° C.

Under many conditions, start-up of the electrochemical fuel cell stack is under high ambient temperatures and the fuel cell stack can be started in a reasonable amount of time and quickly brought to the preferred operating temperature. However, in some fuel cell applications, it may be necessary or desirable to commence operation of an electrochemical fuel cell stack when the stack core temperature is below the freezing temperature of water, or even at subfreezing temperatures below −25° C. At such low temperatures, the fuel cell stack does not operate well and rapid start-up of the fuel cell stack is more difficult. It may thus take a considerable amount of time and/or energy to take an electrochemical fuel cell stack from a cold starting temperature below the freezing temperature of water to efficient operation.

In U.S. Pat. No. 6,358,638, a method of heating a cold MEA to accelerate cold start-up of a PEM fuel cell is disclosed. As described in the '638 patent, either fuel is introduced into the oxidant stream or oxidant is introduced into the fuel stream in the presence of a platinum catalyst on the electrodes to promote an exothermic chemical reaction between hydrogen and oxygen. This reaction locally heats the ion-exchange membrane from below freezing to a suitable operating temperature.

In U.S. patent application Ser. No. 10/774,748, which application is assigned to the assignee of the present invention and is incorporated herein by reference in its entirety, a cooling subsystem for controlling the temperature of a fuel cell system during startup is disclosed. As described in the '748 application, significant improvements in startup time from freezing or subfreezing temperatures can be achieved by using a two pump—dual loop cooling subsystem. In such a system, one pump directs coolant through a startup coolant loop during startup and, after either the fuel cell stack or the coolant temperature reaches a predetermined threshold value, coolant from a main or standard coolant loop is then directed to the fuel cell stack by the other pump.

Accordingly, although there have been advances in the field, there remains a need in the art for more efficient methods of efficiently starting a fuel cell stack at low and sub-freezing temperatures. The present invention addresses these needs and provides further related advantages.

### BRIEF SUMMARY OF THE INVENTION

In brief, the present invention is directed to subsystems and methods for controlling the temperature of an electrochemical fuel cell system during startup.

In one embodiment, a method for operating a cooling subsystem of an electrochemical fuel cell system during startup is provided. As disclosed, the method comprises (1) directing a startup coolant through an electrochemical fuel cell stack of the fuel cell system, and (2) directing a standard coolant through the fuel cell stack when the temperature of either the fuel cell stack or the startup coolant reaches a first predetermined temperature, wherein the heat capacity of the startup coolant is different from the heat capacity of the standard coolant. In further embodiments, the heat capacity of the startup coolant is less than the heat capacity of the standard coolant.

In a further embodiment, the startup coolant comprises a first coolant fluid, and the standard coolant comprises a second coolant fluid. In more specific embodiments, (1) the first and second coolant fluids are liquids, more particularly, the first coolant fluid is a fluorocarbon and the second coolant fluid is a mixture of water and a glycol (such as ethylene glycol or propylene glycol), or (2) the first coolant fluid is a gas and the second coolant fluid is a liquid, more particularly, the first coolant fluid is air and the second coolant fluid is a mixture of water and a glycol (such as ethylene glycol or propylene glycol). In yet other more specific embodiments, the first coolant fluid is a mixture of a gas and a liquid (such as a mixture of air and a fluorocarbon) and the second coolant fluid is a liquid.

In another further embodiment, the startup coolant comprises a mixture of a first coolant fluid and a second coolant fluid, and the standard coolant comprises the second coolant fluid. In more specific embodiments, (1) the first and second coolant fluids are liquids, more particularly, the first coolant fluid is a fluorocarbon and the second coolant fluid is a mixture of water and a glycol (such as ethylene glycol or propylene glycol), or (2) the first coolant fluid is a gas and the second coolant fluid is a liquid, more particularly, the first coolant fluid is air and the second coolant fluid is a mixture of water and a glycol (such as ethylene glycol or propylene glycol). In yet other more specific embodiments, the first coolant fluid is a mixture of a gas and a liquid (such as a mixture of air and a fluorocarbon) and the second coolant fluid is a liquid.

In yet another further embodiment, the startup coolant and standard coolant are directed through the fuel cell stack from a first coolant fluid outlet and a second coolant fluid outlet of a coolant reservoir of the fuel cell system configured to allow separation of the first coolant fluid and the second coolant fluid contained in the coolant reservoir.

In a second embodiment, a cooling subsystem for an electrochemical fuel cell system having an electrochemical fuel cell stack is provided. As disclosed, the cooling subsystem comprises (1) a coolant reservoir fluidly connected to the fuel cell stack, wherein the coolant reservoir is configured to allow separation of a first coolant fluid and a second coolant fluid contained in the coolant reservoir, and wherein the coolant reservoir comprises a first coolant fluid outlet and a second coolant fluid outlet, and (2) a standard coolant loop fluidly connected to the fuel cell stack and both the first coolant fluid outlet and the second coolant fluid outlet of the coolant reservoir, the standard coolant loop comprising a standard pump, wherein a startup coolant, comprising the first coolant fluid or a mixture of the first coolant fluid and the second coolant fluid, is directed through the fuel cell stack during startup of the fuel cell system and a standard coolant, comprising the second coolant fluid, is directed through the fuel cell stack when the temperature of either the fuel cell stack or the startup coolant reaches a first predetermined temperature.

In a further embodiment, the standard coolant loop is fluidly connected to the first coolant fluid outlet of the coolant reservoir by a first coolant fluid inlet line.

In yet another further embodiment, the cooling subsystem further comprises a startup coolant loop fluidly connected to, and bypassing a section of, the standard coolant loop, wherein the startup coolant loop comprises a startup pump, and wherein the startup coolant is directed through the fuel cell stack by the startup coolant loop during startup of the fuel cell stack and the standard coolant is directed through the fuel cell stack by the standard coolant loop when the temperature of either the fuel cell stack or the startup coolant reaches a first predetermined temperature.

In a more specific embodiment of the foregoing, the coolant volume in the startup coolant loop is less than the coolant volume in the standard coolant loop.

These and other aspects of the invention will be evident upon reference to the attached figures and following detailed description.

### BRIEF DESCRIPTION OF THE DRAWINGS

FIG. 1 is a schematic diagram of one embodiment of a cooling subsystem for an electrochemical fuel cell system.

FIG. 2 is a schematic diagram of another embodiment of a cooling subsystem for an electrochemical fuel cell system.

FIG. 3 is a schematic diagram of another embodiment of a cooling subsystem for an electrochemical fuel cell system.

FIG. 4 illustrates one embodiment of the coolant reservoir of the cooling subsystem of FIG. 3.

FIG. 5 is a graph of coolant temperature and current as a function of time for an electrochemical fuel cell system using a mixture of air, water and glycol as the coolant.

FIG. 6 is a graph of coolant temperature and current as a function of time for an electrochemical fuel cell system using a mixture of water and glycol as the coolant.

### DETAILED DESCRIPTION OF THE INVENTION

Temperature regulation of a fuel cell system is typically performed with a coolant circulated throughout a cooling subsystem. Common coolants include, for example, water, ethylene glycol, propylene glycol, fluorocarbons, alcohols or a combination thereof. Choice of coolant is dictated in part, by the physical conditions the fuel cell stack is expected to be subjected to. For example, if the fuel cell stack will be operated in freezing or sub-freezing temperatures, a coolant would likely be chosen such that it would not freeze under such conditions. The primary purpose of a coolant is to regulate temperature and prevent over-heating of the fuel cell stack, as well as other components in the fuel cell system, such as, for example, the compressor, cathode feed, propulsion system, car heating, motors, electronics, etc. However, during startup, and particularly when the fuel cell stack is subjected to freezing or sub-freezing temperatures, the coolant can also assist in bringing the fuel cell stack to its optimal operating temperature.

Since the coolant itself must also be heated during startup, the thermal mass of the coolant is a significant factor influencing startup times from freezing or subfreezing temperatures. Accordingly, changes in the thermal properties of the coolant may result in improvements in startup times. As noted above, U.S. patent application Ser. No. 10/774,748, which application is assigned to the assignee of the present invention and is incorporated herein by reference in its entirety, discloses a two-pump—dual loop cooling subsystem which restricts the coolant flow to a smaller “startup” coolant loop during initial operating conditions. Although such a startup coolant loop reduces the thermal volume of the coolant, the thermal mass of coolant present is still a significant factor.

In order to reduce startup times, the subsystems and methods of the present invention utilize two different coolant fluids, having different heat capacities, to reduce the overall heat capacity of the coolant circulating through the fuel cell stack during startup conditions. For example, as noted above, one embodiment of the present invention provides a method for operating a cooling subsystem of an electrochemical fuel cell system during startup comprising first directing a startup coolant through an electrochemical fuel cell stack of the fuel cell system, and then directing a standard coolant through the fuel cell stack when the temperature of either the fuel cell stack or the startup coolant reaches a first predetermined temperature. As further noted above, in such a method, the heat capacity of the startup coolant may be less than the heat capacity of the standard coolant.

As used herein, the term “heat capacity” refers to the volumetric heat capacity of a fluid. Furthermore, the terms “first predetermined temperature” and “second predetermined temperature” refer to desired operating temperatures of the fuel cell system, for example, from 50 to 90° C. In certain embodiments, the startup coolant utilized in the subsystems and methods of the present invention may comprise either (1) a first coolant fluid or (2) a mixture of a first coolant fluid and a second coolant fluid, whereas, the standard coolant may comprise only the second coolant fluid. In other embodiments, the standard coolant may also comprise a mixture of the first coolant fluid and the second coolant, wherein the ratio of the first and second coolant fluids are different than the ratio of the first and second coolant fluids in the startup coolant. The first and second coolant fluids are selected such that the first coolant fluid has a lower heat capacity than the second coolant fluid. In this way, the heat capacity of the startup coolant will be less than the heat capacity of the standard coolant. Representative first coolant fluids include gases, such as air, hydrogen or nitrogen, liquids, such as fluorocarbons, and mixtures thereof, such as a mixture of air and a fluorocarbon. Representative second coolant fluids include gases, but typically would be liquids, such as methanol and mixtures of water and a glycol (e.g., ethylene glycol or propylene glycol).

As described in more detail below, the subsystems of the present invention comprise a coolant reservoir, fluidly connected to the fuel cell stack, that is configured to allow separation of a first coolant fluid and a second coolant fluid contained therein, and that has both a first coolant fluid outlet and a second coolant fluid outlet. A standard coolant loop, fluidly connected to the fuel cell stack and both the first coolant fluid outlet and the second coolant fluid outlet of the coolant reservoir, directs the first coolant fluid or a mixture of the first coolant fluid and the second coolant fluid (i.e., the startup coolant) through the fuel cell stack during startup of the fuel cell system and directs the second coolant fluid (i.e., the standard coolant) through the fuel cell stack when the temperature of either the fuel cell stack or the startup coolant reaches a first predetermined temperature. In addition, the subsystems of the present invention may also incorporate a startup coolant loop as disclosed in U.S. patent application Ser. No. 10/774,748, which may be used to direct the startup coolant through the fuel cell stack during startup of the fuel cell system. Use of the startup coolant loop may be stopped when the temperature of either the fuel cell stack or the startup coolant reaches the first predetermined temperature, or, as described below, use of the startup coolant loop may be stopped when the temperature of either the fuel cell stack or the startup coolant reaches a second predetermined temperature (which may be the same or different than the first predetermined temperature).

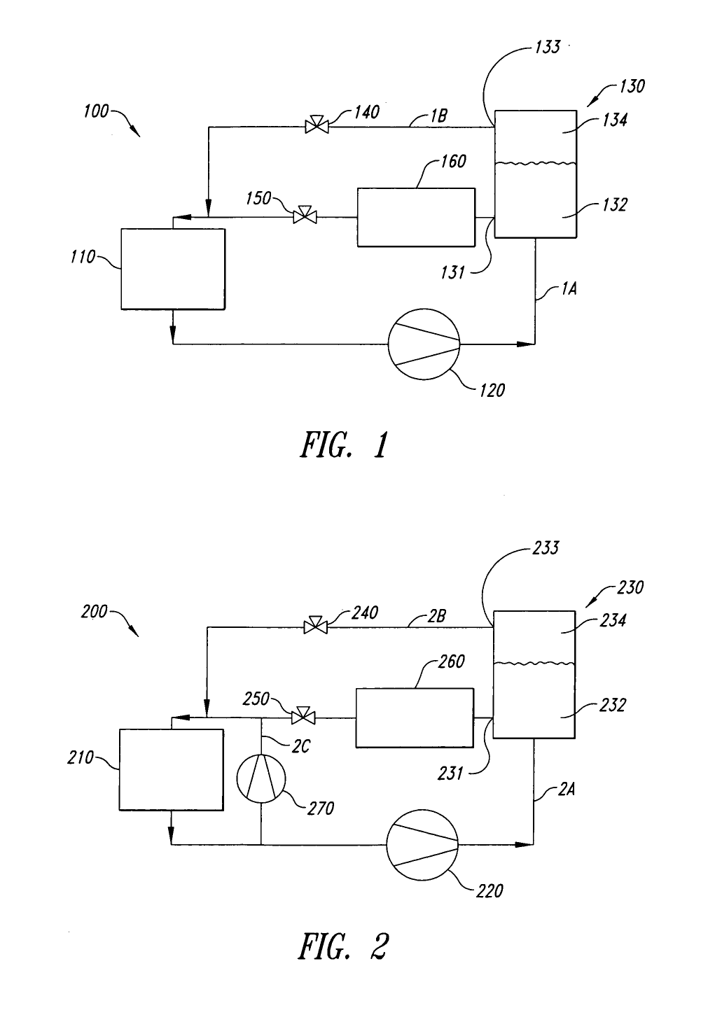

FIG. 1 is a schematic diagram of one embodiment of a cooling subsystem for an electrochemical fuel cell system 100. As shown in FIG. 1, fuel cell system 100 comprises a fuel cell stack 110 and a cooling subsystem comprising a coolant reservoir 130, fluidly connected to fuel cell stack 110, and a standard coolant loop 1A comprising a standard pump 120. Coolant reservoir 130 comprises a first coolant fluid outlet 133 and a second coolant fluid outlet 131, both of which are fluidly connected to standard coolant loop 1A. In addition, coolant reservoir 130 is configured to allow separation, by, for example, phase separation, of a first coolant fluid 134 and a second coolant fluid 132 contained therein.

In the arrangement illustrated in FIG. 1, upon separation, first coolant fluid 134 will rise to the top of coolant reservoir 130 and second coolant fluid 132 will settle to the bottom of coolant reservoir 130. In this way, the illustrated arrangement is adapted for use with a cooling subsystem utilizing a first coolant fluid such as air and a second coolant fluid such as a mixture of water and a glycol.

In the embodiment of FIG. 1, standard coolant loop 1A further comprises a heat exchanger 160, such as a radiator, and a valve 150. Also in the illustrated embodiment, standard coolant loop 1A is fluidly connected to first coolant fluid outlet 133 by a first coolant fluid inlet line 1B comprising a valve 140.

Operation of the cooling subsystem is commenced by turning on standard pump 120 and opening valves 140 and 150 such that a startup coolant, comprising a mixture of first coolant fluid 134 and second coolant fluid 132, is directed through fuel cell stack 110 during startup of fuel cell system 100. During this initial period of operation, valves 140 and 150 may be adjusted to control the composition of the startup coolant (e.g., to yield a startup coolant that is 70% first coolant fluid/30% second coolant fluid or 30% first coolant fluid/70% second coolant fluid). Alternatively, valve 150 may be kept closed such that the startup coolant directed through fuel cell stack 110 comprises first coolant fluid 134 only. The startup coolant is re-circulated into coolant reservoir 130, where first and second coolant fluids 134 and 132 are separated.

After the temperature of either fuel cell stack 110 or the startup coolant reaches a first predetermined temperature, valve 140 is closed and valve 150 is opened. In this way, once all of the startup coolant in standard coolant loop 1A has been re-circulated into coolant reservoir 130, and separated therein, a standard coolant, comprising second coolant fluid 132 only, will be directed through fuel cell stack 110. By slowly replacing any first coolant fluid 134 circulating in standard coolant loop 1A with second coolant fluid 132 in the foregoing manner, any potential thermal impact on fuel cell stack 110 is minimized.

FIG. 2 is a schematic diagram of another embodiment of a cooling subsystem for an electrochemical fuel cell system 200. As in fuel cell system 100 of FIG. 1, fuel cell system 200 comprises a fuel cell stack 210 and a cooling subsystem comprising a coolant reservoir 230, fluidly connected to fuel cell stack 210, and a standard coolant loop 2A comprising a standard pump 220. Coolant reservoir 230 comprises a first coolant fluid outlet 233 and a second coolant fluid outlet 231, both of which are fluidly connected to standard coolant loop 2A. Similar to coolant reservoir 130, coolant reservoir 230 is configured to allow separation of a first coolant fluid 234 and a second coolant fluid 232 contained therein.

Also as in the embodiment of FIG. 1, in the embodiment of FIG. 2, standard coolant loop 2A further comprises both a heat exchanger 260 and a valve 250, and is fluidly connected to first coolant fluid outlet 233 by a first coolant fluid inlet line 2B comprising a valve 240. However, the embodiment of FIG. 2 also further comprises a startup coolant loop 2C, comprising a startup pump 270, fluidly connected to, and bypassing a section of, standard coolant loop 2A. The coolant volume in startup coolant loop 2C may be less than the coolant volume in standard coolant loop 2A.

Operation of the cooling subsystem of FIG. 2 is commenced by turning on standard pump 220 and opening valves 240 and 250 such that a startup coolant, comprising a mixture of first coolant fluid 234 and second coolant fluid 232, is directed through fuel cell stack 210. As above, valves 240 and 250 may be adjusted to control the composition of the startup coolant or valve 250 may be kept closed such that the startup coolant comprises first coolant fluid 234 only. After the desired composition of the startup coolant has been achieved, standard pump 220 is turned off, valves 240 and 250 are closed and startup pump 270 is turned on such that the startup coolant is continuously circulated through fuel cell stack 210 and startup coolant loop 2C. In an alternate embodiment, the startup coolant may be introduced into startup coolant loop 2C during shutdown of fuel cell stack 210 and, in this way, operation of the cooling subsystem of FIG. 2 may be commenced during startup by simply turning on startup pump 270. After the temperature of either fuel cell stack 210 or the startup coolant reaches a first predetermined temperature, valve 250 is opened, startup pump 270 is turned off and standard pump 220 is turned on. In this way, as in the subsystem of FIG. 1, once all of the startup coolant in standard coolant loop 2A has been re-circulated into coolant reservoir 230, and separated therein, a standard coolant, comprising second coolant fluid 232 only, will be directed through standard coolant loop 2A and fuel cell stack 210.

In one variation of this embodiment, startup pump 270 is turned off, standard pump 220 is turned on and valves 240 and 250 are opened when the temperature of either fuel cell stack 210 or the startup coolant reaches a second predetermined temperature (which may be the same or different than the first predetermined temperature), and valve 240 is closed when either fuel cell stack 210 or the startup coolant reaches the first predetermined temperature. In another variation of this embodiment, standard pump 220 is turned on and valve 250 is opened when the temperature of either fuel cell stack 210 or the startup coolant reaches the first predetermined temperature, and startup pump 270 is turned off when either fuel cell stack 210 or the startup coolant reaches a second predetermined temperature (which may be the same or different than the first predetermined temperature).

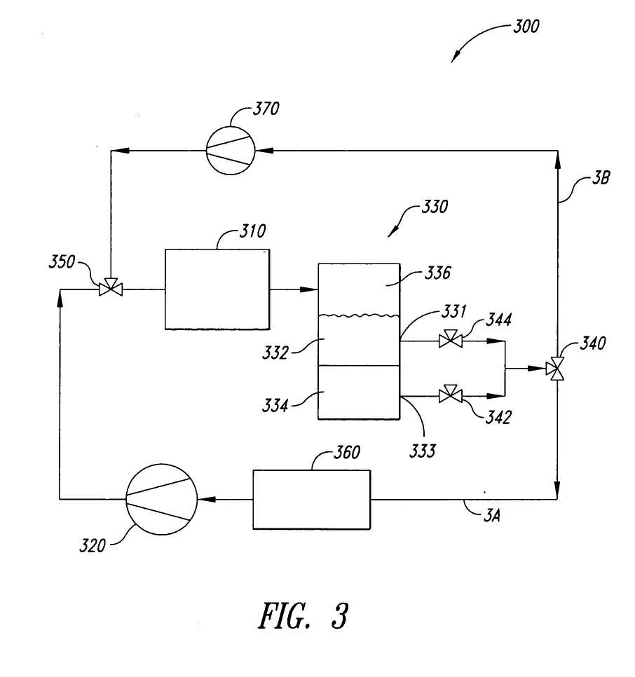

FIG. 3 is a schematic diagram of yet another embodiment of a cooling subsystem for an electrochemical fuel cell system 300. As shown in FIG. 3, fuel cell system 300 comprises a fuel cell stack 310 and a cooling subsystem comprising a coolant reservoir 330, fluidly connected to fuel cell stack 310, and a standard coolant loop 3A comprising a standard pump 320. Coolant reservoir 330 comprises a first coolant fluid outlet 333 and a second coolant fluid outlet 331, both of which are fluidly connected to standard coolant loop 3A. In addition, coolant reservoir 330 is configured to allow separation, by, for example, phase separation, of a first coolant fluid 334 and a second coolant fluid 332 contained therein.

In the arrangement illustrated in FIG. 3, upon separation, first coolant fluid 334 will settle to the bottom of coolant reservoir 330 and second coolant fluid 332 will rise to the top of coolant reservoir 330. In this way, the illustrated arrangement is adapted for use with a cooling subsystem utilizing a first coolant fluid such as a fluorocarbon and a second coolant fluid such as a mixture of water and a glycol. As further shown in FIG. 3, coolant reservoir 330 may be configured to have an air gap 336 to allow for pressure surges within the cooling subsystem.

As further illustrated, in the embodiment of FIG. 3, standard coolant loop 3A further comprises a heat exchanger 360, such as a radiator, and four valves 340, 342, 344 and 350 adapted to control the flow of first and second coolant fluids 334 and 332 through standard coolant loop 3A.

Operation of the cooling subsystem of FIG. 3 is commenced by turning on standard pump 320 and opening valves 340, 342, 344 and 350 such that a startup coolant, comprising a mixture of first coolant fluid 334 and second coolant fluid 332, is directed through fuel cell stack 310 during startup of fuel cell system 300. During this initial period of operation, valves 342 and 344 may be adjusted to control the composition of the startup coolant (e.g., to yield a startup coolant that is 70% first coolant fluid/30% second coolant fluid or 30% first coolant fluid/70% second coolant fluid). Alternatively, valve 344 may be kept closed such that the startup coolant directed through fuel cell stack 310 comprises first coolant fluid 334 only. The startup coolant is re-circulated into coolant reservoir 330, where first and second coolant fluids 334 and 332 are separated.

After the temperature of either fuel cell stack 310 or the startup coolant reaches a first predetermined temperature, valve 342 is closed and valve 344 is opened. In this way, once all of the startup coolant in standard coolant loop 3A has been re-circulated into coolant reservoir 330, and separated therein, a standard coolant, comprising second coolant fluid 332 only, will be directed through fuel cell stack 310.

As further shown in FIG. 3, in a further embodiment, the cooling subsystem of fuel cell system 300 may also comprise a startup coolant loop 3B comprising a startup pump 370, fluidly connected to, and bypassing a section of, standard coolant loop 3A. As with startup coolant loop 2C in the embodiment of FIG. 2, the coolant volume in startup coolant loop 3B may be less than the coolant volume in standard coolant loop 3A.

Operation of this further embodiment is commenced by turning on startup pump 370 and opening valves 340, 342, 344 and 350 such that a startup coolant, comprising a mixture of first coolant fluid 334 and second coolant fluid 332, is directed through startup coolant loop 3B and fuel cell stack 310 during startup of fuel cell system 300. As above, during this initial period of operation, valves 342 and 344 may be adjusted to control the composition of the startup coolant or valve 344 may be kept closed such that the startup coolant directed through fuel cell stack 310 comprises first coolant fluid 334 only. In further embodiments, the cooling subsystem of FIG. 3 may be modified such that the startup coolant comprises a first coolant fluid comprising both a gas and a liquid.

After the temperature of either fuel cell stack 310 or the startup coolant reaches a first predetermined temperature, valve 342 is closed, valves 340 and 350 are adjusted, startup pump 370 is turned off and standard pump 320 is turned on such that a standard coolant, comprising second coolant fluid 332 only, will be directed through standard coolant loop 3A and fuel cell stack 310. As in FIG. 2, in variations of this embodiment, startup pump 370 may instead be turned off when the temperature of either fuel cell stack 310 or the startup coolant reaches a second predetermined temperature (which may be the same or different than the first predetermined temperature).

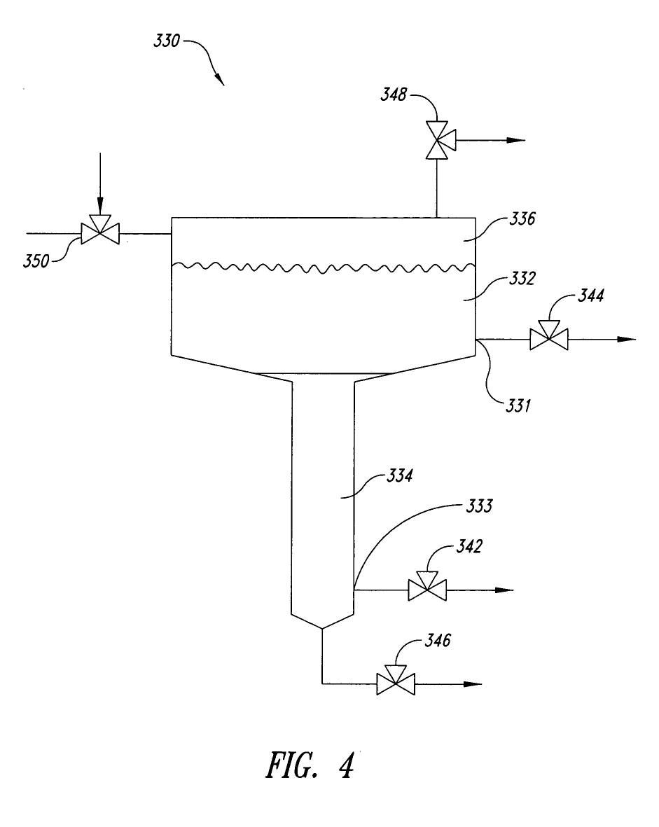

FIG. 4 illustrates one embodiment of coolant reservoir 330 of the cooling subsystem of FIG. 3. As in FIG. 3, coolant reservoir 330 of FIG. 4 comprises a first coolant fluid outlet 333, a second coolant fluid outlet 331, and an air gap 336. For purposes of clarification and orientation, valves 342, 344 and 350 are also shown.

FIG. 4 further shows that coolant reservoir 330 may comprise a pressure release valve 348 fluidly connected to the portion of coolant reservoir 330 comprising air gap 336 and a maintenance drain 346 connected to the bottom of coolant reservoir 330. In addition, coolant reservoir 330 may be shaped such that the bottom portion of coolant reservoir 330, into which first coolant fluid 334 will settle, has a smaller volume than the upper portion of coolant reservoir 330, into which second coolant fluid 332 will rise. In this way, the embodiment of FIG. 4 is adapted for use with a cooling subsystem, such as the subsystem of FIG. 3, wherein the coolant volume in the startup coolant loop is less than the coolant volume in the standard coolant loop.

While the above embodiment have been described with respect to accelerating the startup times from freezing or subfreezing temperatures, it is understood that the above embodiments could also be adapted to accelerate startup times from ambient conditions and improve operating performance at low current densities by maintaining optimal fuel cell stack temperature. In this regard, it is noted that maintaining the optimal operating temperature of a fuel cell stack improves water management within the stack, potentially increases the lifetime of the stack, and results in greater stack efficiency, thereby leading to increased fuel economy. Further still, it is understood that the above embodiments could also be adapted to increase startup times if desired using two coolant fluids with differing heat capacities.

### EXAMPLES

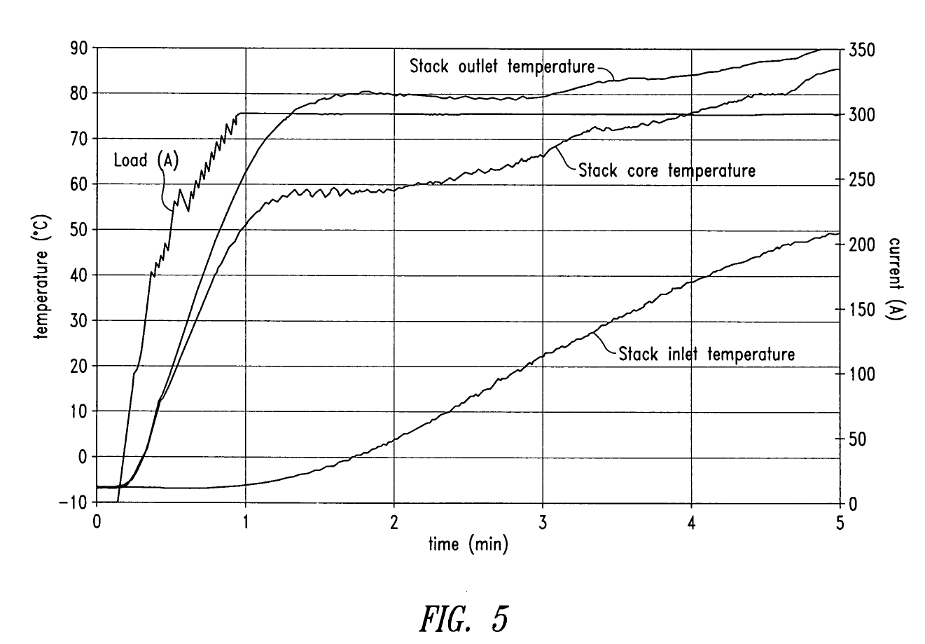

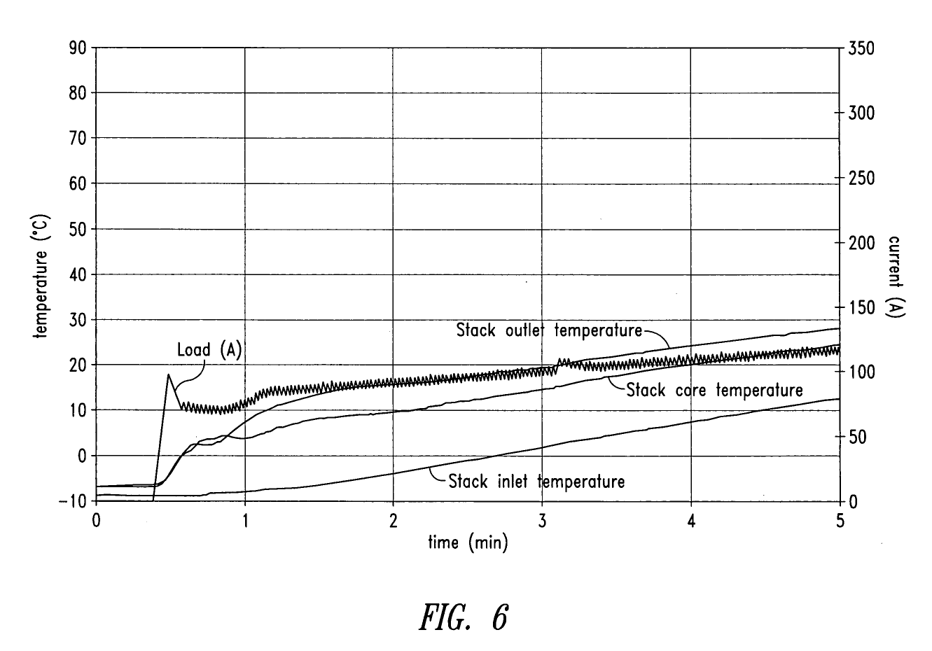

A 10-cell automotive type stack was shutdown appropriately for storage and frozen to −15° C. In the first test case, a conventional water/ethylene glycol coolant was employed. In the second test case, a substantial amount of air was introduced along with the conventional water/ethylene glycol coolant. In both cases, startup comprised starting a flow of the cold coolant through a first coolant loop. Air and fuel reactants were then supplied and an electrical load was applied. The load was increased relatively quickly, but not such that any cell voltage in the stack fell below 200 mV. After the stack reached 65° C., the coolant was mixed with a larger, second coolant loop. This second coolant loop had an air gap at the top such that any air in the coolant mixture could separate out. Temperatures at various points in the stack (e.g., stack inlet, stack outlet and stack core) were measured as shown in FIGS. 5 and 6. FIG. 5 is a graph of coolant temperature as a function of time for the second test case, and FIG. 6 is a graph of coolant temperature as a function of time for the first test case. The electrical load applied is also shown in each of FIGS. 5 and 6. As shown, the stack of the second test case heated up much faster than the stack of the first test case.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

1. A method for operating a cooling subsystem of an electrochemical fuel cell system during startup, the method comprising:
directing a startup coolant through an electrochemical fuel cell stack of the fuel cell system; and
directing a standard coolant through the fuel cell stack when the temperature of either the fuel cell stack or the startup coolant reaches a first predetermined temperature,
wherein the heat capacity of the startup coolant is different from the heat capacity of the standard coolant.

2. The method of claim 1 wherein the heat capacity of the startup coolant is less than the heat capacity of the standard coolant.

3. The method of claim 1 wherein the startup coolant comprises a first coolant fluid, and the standard coolant comprises a second coolant fluid.

4. The method of claim 3 wherein the first and second coolant fluids are liquids.

5. The method of claim 4 wherein the first coolant fluid is a fluorocarbon and the second coolant fluid is a mixture of water and a glycol.

6. The method of claim 5 wherein the glycol is ethylene glycol.

7. The method of claim 5 wherein the glycol is propylene glycol.

8. The method of claim 3 wherein the first coolant fluid is a gas and the second coolant fluid is a liquid.

9. The method of claim 8 wherein the first coolant fluid is air and the second coolant fluid is a mixture of water and a glycol.

10. The method of claim 9 wherein the glycol is ethylene glycol.

11. The method of claim 9 wherein the glycol is propylene glycol.

12. The method of claim 3 wherein the first coolant fluid is a mixture of a gas and a liquid and the second coolant fluid is a liquid.

13. The method of claim 12 wherein the first coolant fluid is a mixture of air and a fluorocarbon.

14. The method of claim 1 wherein the startup coolant comprises a mixture of a first coolant fluid and a second coolant fluid, and the standard coolant comprises the second coolant fluid.

15. The method of claim 14 wherein the first and second coolant fluids are liquids.

16. The method of claim 15 wherein the first coolant fluid is a fluorocarbon and the second coolant fluid is a mixture of water and a glycol.

17. The method of claim 16 wherein the glycol is ethylene glycol.

18. The method of claim 16 wherein the glycol is propylene glycol.

19. The method of claim 14 wherein the first coolant fluid is a gas and the second coolant fluid is a liquid.

20. The method of claim 19 wherein the first coolant fluid is air and the second coolant fluid is a mixture of water and a glycol.

21. The method of claim 20 wherein the glycol is ethylene glycol.

22. The method of claim 20 wherein the glycol is propylene glycol.

23. The method of claim 14 wherein the first coolant fluid is a mixture of a gas and a liquid and the second coolant fluid is a liquid.

24. The method of claim 23 wherein the first coolant fluid is a mixture of air and a fluorocarbon.

25. The method of claim 1 wherein the startup coolant and standard coolant are directed through the fuel cell stack from a first coolant fluid outlet and a second coolant fluid outlet of a coolant reservoir of the fuel cell system configured to allow separation of the first coolant fluid and the second coolant fluid contained in the coolant reservoir.

26. A cooling subsystem for an electrochemical fuel cell system having an electrochemical fuel cell stack, the cooling subsystem comprising:
a coolant reservoir fluidly connected to the fuel cell stack, wherein the coolant reservoir is configured to allow separation of a first coolant fluid and a second coolant fluid contained in the coolant reservoir, and wherein the coolant reservoir comprises a first coolant fluid outlet and a second coolant fluid outlet; and
a standard coolant loop fluidly connected to the fuel cell stack and both the first coolant fluid outlet and the second coolant fluid outlet of the coolant reservoir, the standard coolant loop comprising a standard pump,
wherein a startup coolant, comprising the first coolant fluid or a mixture of the first coolant fluid and the second coolant fluid, is directed through the fuel cell stack during startup of the fuel cell system and a standard coolant, comprising the second coolant fluid, is directed through the fuel cell stack when the temperature of either the fuel cell stack or the startup coolant reaches a first predetermined temperature.

27. The cooling subsystem of claim 26 wherein the standard coolant loop is fluidly connected to the first coolant fluid outlet of the coolant reservoir by a first coolant fluid inlet line.

28. The cooling subsystem of claim 26, further comprising a startup coolant loop fluidly connected to, and bypassing a section of, the standard coolant loop, wherein the startup coolant loop comprises a startup pump, and wherein the startup coolant is directed through the fuel cell stack by the startup coolant loop during startup of the fuel cell stack and the standard coolant is directed through the fuel cell stack by the standard coolant loop when the temperature of either the fuel cell stack or the startup coolant reaches a first predetermined temperature.

29. The cooling subsystem of claim 28 wherein the coolant volume in the startup coolant loop is less than the coolant volume in the standard coolant loop.
